(19) United States
(12) Patent Application Publication
(10) Pub. No.: US 2008/0099712 A1
(43) Pub. Date: May 1, 2008

(54) CARTRIDGE BALL VALVE

(75) Inventor: Donald A. DeYoe, Newmarket (CA)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/552,715

(22) Filed: Oct. 25, 2006

(51) Int. Cl. F16K 5/06

(52) U.S. Cl. 251/315.01

(57) ABSTRACT

Valves such as ball valves may be configured so that they may be field serviced without removing the entire valve from a piping system. In some cases, the ball valves may be configured to be fluid tight while exhibiting low friction thus allowing a relatively low turning force. Such valves may include a valve body and a valve assembly disposed within the valve body. The valve assembly may include a ball valve disposed within a replaceable cartridge.

### TECHNICAL FIELD

The present invention relates generally to water delivery and water circulation systems, and more particularly, to water delivery and water circulation systems that use valves.

### BACKGROUND

Water delivery and water circulation systems are commonly used today in a wide variety of applications. For example, buried sprinkler systems are commonly used to irrigate lawns and other plants in both residential and commercial settings. Fire prevention sprinkler systems are commonly installed in buildings to help prevent the spread of fires. Water circulation systems are commonly used to heat and/or cool both residential and commercial buildings. These are just a few examples of water delivery and water circulation systems.

Water delivery and water circulation systems often include a network of pipes. In many cases, one or more valves are used to control the water flow through all of part of the pipes of the distribution network. In some cases, the network of pipes is broken up into zones, where some or all of the zones can be independently controlled by one or more corresponding valves.

In some cases, the valves used to control the water flow can often be reversibly opened and closed to permit or prevent water flow. The valves sometimes can be opened and closed manually, or opened and closed automatically. Automatic control valves in use today often include a motor or solenoid that can be energized to open and/or close the valve. In many cases, the valves may be controlled by a controller. In heating and/or cooling applications, for example, the controller may be a thermostat.

Some valves are ball valves, in which a ball-shaped structure having an aperture formed within the ball-shaped structure may be rotated between a position in which fluid flow is permitted through the aperture (and thus through the valve) and a position in which fluid flow is not permitted. A need remains for valves such as ball valves that may be field serviced without removing the entire valve from a piping system. A need also remains for ball valves that are fluid tight but exhibit relatively low friction and/or that can be configured to provide a desired flow profile.

### SUMMARY

The present invention pertains to valves such as ball valves that may be field serviced without removing the entire valve from a piping system. In some embodiments, the ball valves may be fluid tight while exhibiting relatively low turning friction, and/or may be configurable to provide a desired flow profile as the valve is moved between an open and closed position.

An illustrative but non-limiting example of the present invention may be found in a valve that includes a valve body defining a valve cavity and a valve assembly that is disposed within the valve cavity. The valve assembly may include a main cartridge that has first and second seals disposed within the main cartridge. In some cases, the main cartridge may include a profile window that is integrally molded into the main cartridge, but this is not required. A ball valve may be disposed within the main cartridge, between the first seal and the second seal. The first seal and the second seal may be held against the ball valve via a compressive force generated between the main cartridge and the valve cavity. In some cases, the first seal and the second seal may each include a low friction polymeric seal, such as a polytetrafluoroethylene seal. This may reduce the friction experienced when opening and/or closing the valve

In some illustrative embodiments, the main cartridge may include a first cartridge half and an opposing second cartridge half. The first cartridge half and the second cartridge half may fit loosely together such that the first cartridge half and the second cartridge half are able to move closer together in response to a compressive force applied to the cartridge haves by the valve cavity, sometimes via one or more O-rings. If desired, the first cartridge half and the second cartridge half may be adapted to snap loosely together, but this is not required. In some cases, a first O-ring may be disposed on or within an exterior surface of the first cartridge half and a second O-ring may be disposed on or within an exterior surface of the second cartridge half. In some instances, the first O-ring and the second O-ring may contact the valve cavity and exert a compressive force to the main cartridge.

Another illustrative but non-limiting example of the present invention may be found in a ball valve cartridge assembly that includes a first cartridge half and a second cartridge half. In some cases, the first cartridge half and the second cartridge half may be moveably secured together. A ball valve assembly may be disposed between the first cartridge half and the second cartridge half. A first polymeric seal may be disposed in contact with the first cartridge half and in sliding contact with the ball valve assembly. A second polymeric seal may be disposed in contact with the second cartridge half and in sliding contact with the ball valve assembly. In some instances, the first polymeric seal may be molded into the first cartridge half, and the second polymeric seal may be molded into the second cartridge half. In other cases, the first and second polymeric seals may be separately formed, sometimes of a low friction material, and may be received by the first cartridge half and the second cartridge half, respectively.

Another illustrative but non-limiting example of the present invention may be found in a ball valve cartridge assembly having a main cartridge that includes a first cartridge section and a second cartridge section. In some cases, the ball valve cartridge may include more than two cartridge sections, if desired. A first seal and a second seal may be disposed within the main cartridge. A ball valve may be disposed within the main cartridge and contact the first seal and the second seal. A profile window may be molded into one of the cartridge sections, such as the first cartridge section. In some cases, an upper cartridge may be disposed above the main cartridge, but this is not required in all embodiments. In some cases, the first cartridge section and/or the second cartridge section may be molded polymer sections. The upper cartridge may, if included, also be a molded polymer, but this is not required. In some cases, the first seal and/or the second seal may be at least partially spherically shaped annular seals, but again, this is not required.

The above summary of the present invention is not intended to describe each disclosed embodiment or every implementation of the present invention. The Figures and Detailed Description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is an exploded perspective view of a valve cartridge assembly in accordance with an illustrative but non-limiting example of the present invention;

FIG. 2 is an assembled perspective view of the valve cartridge assembly of FIG. 1;

FIG. 3 is a perspective view of a valve in accordance with an illustrative but non-limiting example of the present invention;

FIG. 4 is a partial cross-section of the valve of FIG. 3; and

FIG. 5 is a partial cross-section of a valve in accordance with an illustrative but non-limiting example of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all passive and active modifications, equivalents, and alternatives falling within the spirit and scope of the invention.

### DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

The present invention relates generally to valves such as ball valves that may be field serviced without removing the entire valve from a piping system. In some cases, the ball valves may be fluid tight while exhibiting low friction, and/or can exhibit a desired flow profile. The valve may include a field-serviceable and/or replaceable cartridge assembly that includes a ball valve, but this is not required.

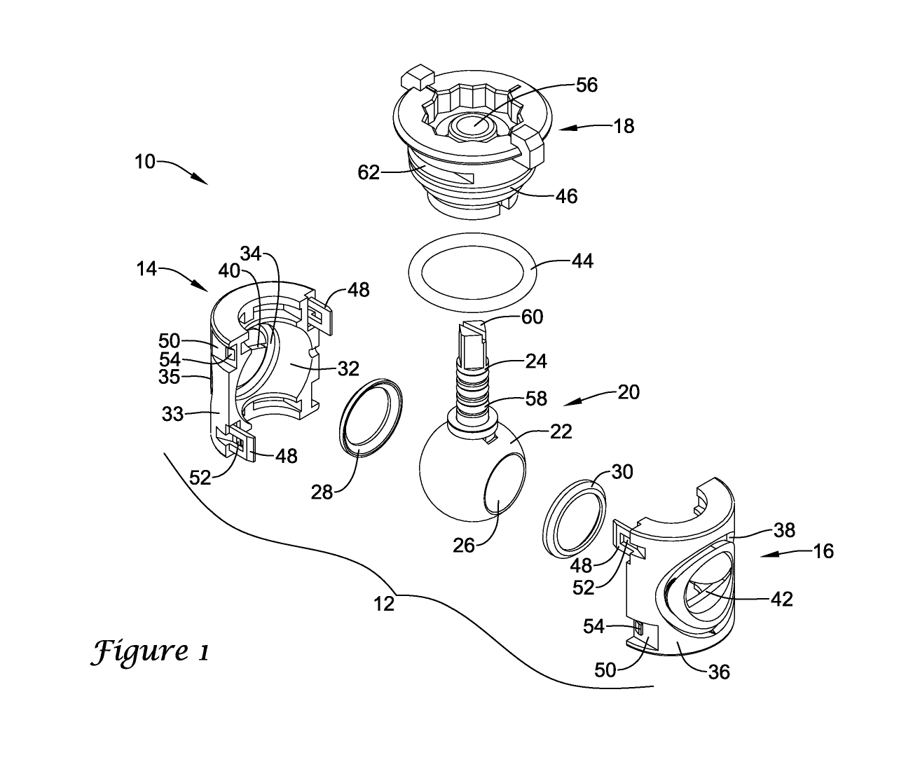

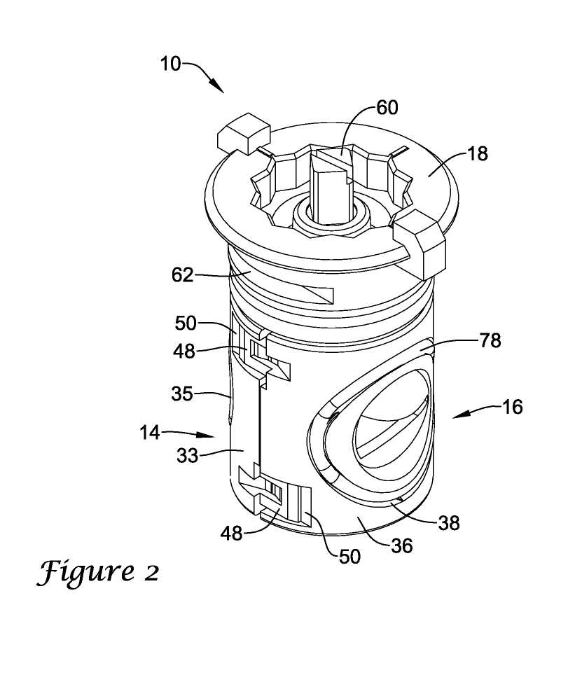

FIG. 1 provides an exploded perspective view of an illustrative valve assembly 10 while FIG. 2 shows valve assembly 10 in an assembled configuration. Valve assembly 10 includes a main cartridge 12 that can be seen as including a first cartridge half 14 and a second cartridge half 16. In this, designations of first and second are arbitrary. Valve assembly 10 may, as illustrated, also include an upper cartridge 18. A ball valve assembly 20 including a ball valve 22 and a stem 24 is disposed between first cartridge half 14 and second cartridge half 16. While main cartridge 12 is illustrated as having first cartridge half 14 and second cartridge half 16, it is contemplated that main cartridge 12 may instead be divided into three, four or more distinct sections that may be assembled together to form main cartridge 12, if desired.

Ball valve 22 includes an aperture 26 that may be adapted to permit fluid to flow through the ball valve 22 when the ball valve 22 is oriented in an open position (as illustrated). It will be recognized that ball valve 22 may be turned to a closed position in which fluid cannot flow through aperture 26. In some cases, ball valve 22 may be turned to a closed position by rotating stem 24 (and hence ball valve 22) about a quarter-turn, or about 90 degrees. Ball valve 22 may be formed of any suitable metallic, polymeric or other material. In some cases, ball valve 22 is brass. The stem 24 may be integrally formed with ball valve 22, or separately formed and then subsequently secured to ball valve 22.

Disposed on either side of ball valve 22 are a first seal 28 and a second seal 30. As illustrated, first seal 28 and second seal 30 may be considered as having an at least partially spherical shape in that they are curved to at least substantially match a radius of curvature of ball valve 22. As a result, ball valve 22 may rotate smoothly between first seal 28 and second seal 30 while permitting first seal 28 and second seal 30 to provide a fluid-tight seal against ball valve 22. First seal 28 and second seal 30 are also shown as being annular, so that they do not restrict or at least do not substantially restrict fluid flow through aperture 26 when ball valve 22 is in an open position.

In some instances, the first cartridge half 14 and/or the second cartridge half 16 may be configured to accommodate the first seal 28 and/or the second seal 30. In the illustrative embodiment, first cartridge half 14 can be seen as having an interior surface 32 that includes an annular depression 34 having a profile complementary to first seal 28 such that the first seal 28 may fit into annular depression 34. Likewise, the second cartridge half 16 may have an interior surface that includes an annular depression configured to accommodate the second seal 30. The interior surface of second cartridge half 16 is not visible in this view.

In some instances, the first cartridge half 14 and/or the second cartridge half 16 may be formed of any suitable material, using any suitable technique. In some cases, the first cartridge half 14 and/or the second cartridge half 16 may be molded from a suitable polymer. A suitable polymer may be a polymer that can be molded yet has sufficient strength to retain its shape against the temperatures and water pressures that the valve assembly 10 may be exposed to in the field.

Likewise, the first seal 28 and/or the second seal 30 may be formed of any suitable material. In some instances, the first seal 28 and/or the second seal 30 may be formed of a material having a low coefficient of friction, such as certain polyethylene materials as well as a variety of fluoropolymers. In particular cases, the first seal 28 and the second seal 30 may be formed, or having a coating of, a fluoropolymer such as polytetrafluoroethylene, better known as TEFLON®.

In some cases (not illustrated) it is contemplated that the first seal 28 may instead be integrally molded or otherwise formed as part of first cartridge half 14. Similarly, in some cases the second seal 30 may be integrally molded or otherwise formed as part of second cartridge half 16.

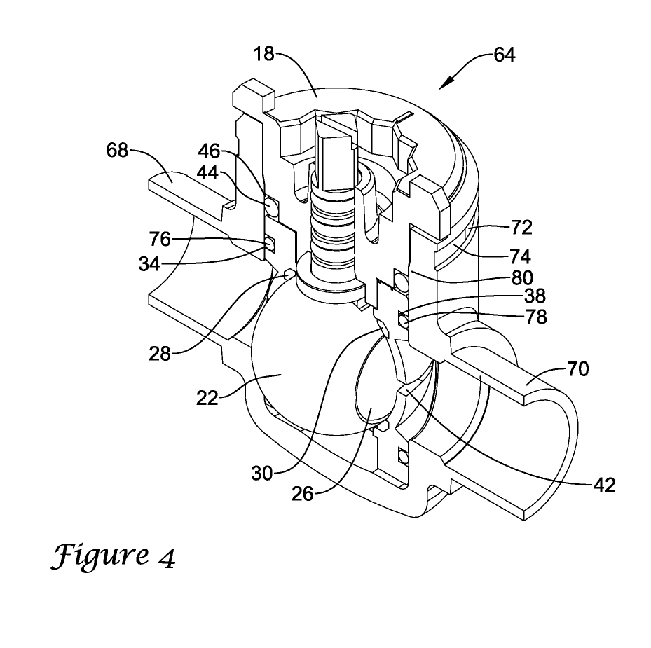

In some instances, the first cartridge half 14 has an exterior surface 33 that includes an annular depression 35 Oust visible in this view) that may be configured to accommodate an O-ring. Likewise, the second cartridge half 16 may, in some cases, have an exterior surface 36 that includes an annular depression 38 that may be configured to accommodate an O-ring, such as an O-ring 78. As will be shown later in FIG. 4, the O-rings accommodated by annular depression 35 and annular depression 38 may play a role in positioning and securing main cartridge 12 within a valve body.

In some cases, annular depression 35 and/or annular depression 38 may be sized to loosely accommodate an O-ring in each annular depression 35 and 38. In some instances, annular depression 35 and/or annular depression 38 may be sized having a semi-circular profile that is somewhat smaller than the cross-section of the O-rings that will be placed in annular depression 35 and annular depression 38 in order to locate and secure the O-rings.

Depending on the particular use of a valve into which valve assembly 10 may be placed, it may be desirable to provide a particular flow profile for the valve. In some cases, first cartridge half 14 and/or second cartridge half 16 may be configured to provide a particular flow profile. In some instances, the first cartridge half 14 may include an integral profile window 40 and/or the second cartridge half 16 may include an integral profile window 42. It is contemplated that, in some cases, only one of profile window 40 or profile window 42 may be present. In other instances, neither profile window 40 nor profile window 42 may be present. If present, profile window 40 and/or profile window 42 may provide a desired flow profile to the valve as the value is opened and/or closed. When the profile window is integral with one of the cartridge halves, there is little chance that the profile window will become misaligned or dislodged relative to the valve.

In the illustrative embodiment, the first cartridge half 14 and second cartridge half 16 may be configured to fit together to form main cartridge 12, with ball valve 22, first seal 28 and second seal 30 disposed within an interior of main cartridge 12. In some cases, an O-ring 44 may be secured within an annular depression 46 located on a lower side of upper cartridge 18. O-ring 44 may provide a fluid-tight seal between main cartridge 12 and upper cartridge 18.

In the illustrative embodiment, the first cartridge half 14 and second cartridge half 16 may fit together relatively loosely, i.e., they are able to move somewhat with respect to each other in response to externally applied forces. In one illustrative embodiment, as illustrated in FIGS. 1 and 2, the first cartridge half 14 and the second cartridge half 16 each include latch pairs including tabs 48 and complementary slots 50 that are configured to accept and retain tabs 48.

In some instances, each tab 48 may include an elongate aperture 52 that is configured to accept a raised portion 54 disposed within each slot 50. It can be seen that each elongate aperture 52 has a length that is greater than a major dimension of the corresponding raised portion 54. Therefore, the interplay between each tab 48 and slot 50 secures the first cartridge half 14 to the second cartridge half 16 yet permits some relative movement between the first cartridge half 14 and the second cartridge half 16.

In some instances, the stem 24 may extend upward through upper cartridge 18. When so provided, the upper cartridge 18 may include an aperture 56 that is sized to accommodate stem 24. Stem 24 may include one or more O-rings 58 that permit stem 24 to rotate relative to upper cartridge 18 yet provide a fluid-tight seal that prevents fluid from leaking through aperture 56.

Stem 24 may, in some instances, include a slotted top 60 that provides an interface between stem 24 and structure that may be adapted to manually or automatically rotate stem 24 and thereby move ball valve 22 from an open position to a closed position, from a closed position to an open position, or from a first open position to a second open position. In some cases, slotted top 60 may accommodate a lever or knob that are adapted to be turned manually. In some instances, slotted top 60 may accommodate a motor-driven assembly that rotates stem 24 in response to a command signal.

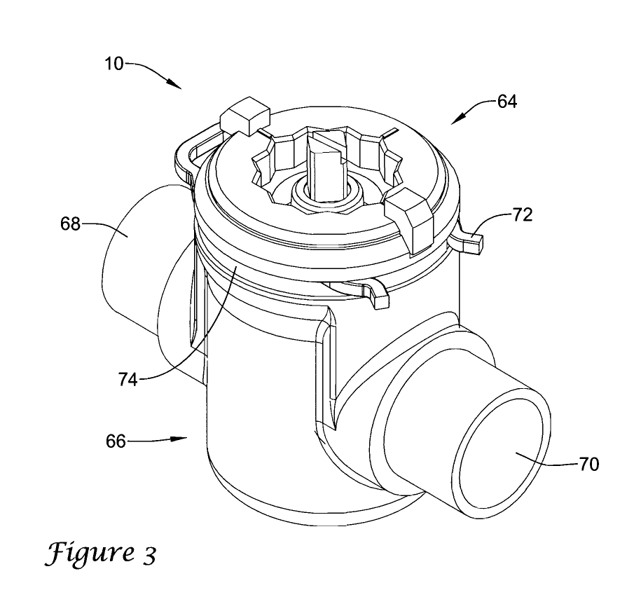

Upper cartridge 18 may, in some instances, include a groove 62 that is configured to accommodate a retainer that may secure valve assembly 10 into a valve body, as will be discussed further below with respect to FIGS. 3 and 4. It will be appreciated that valve assembly 10 may be assembled with ball valve assembly 20, the first seal 28 and second seal 30 disposed between the first cartridge half 14 and the second cartridge half 16. The first cartridge half 14 and the second cartridge half 16 may be snapped together. Upper cartridge 18, including O-ring 44 disposed within annular depression 46, may be dropped over the stem 24. The assembled valve assembly 10 may then be placed into a valve body, as will be discussed further below with respect to FIG. 3 and FIG. 4.

FIG. 3 is a perspective view of an illustrative valve 64 that includes valve assembly 10 (see FIGS. 1 and 2) disposed within a valve body 66. Valve body 66 includes an inlet 68 and an outlet 70. Fluid may flow into inlet 68, through ball valve 22 (FIG. 1) and through outlet 70 if ball valve 22 is in an open or partially open position. In FIG. 3, the valve assembly 10 shown in FIGS. 1 and 2 has been dropped into the valve body 66, and is secured via a retainer 72 that interacts with groove 62 (within upper cartridge 18) as well as a groove 74 that is formed within valve body 66.

FIG. 4 is a partial cross-section of valve 64 showing additional elements. A first O-ring 76 is disposed within annular depression 35 within the first cartridge half 14. Similarly, a second O-ring 78 is disposed within annular depression 38 within the second cartridge half 16. First seal 28 is disposed about one side of ball valve 22 while second seal 30 is disposed about an opposite side of ball valve 22. A profile window 42 is visible within second cartridge half 16. Valve body 66 defines a valve cavity 80 that may be configured to accommodate valve assembly 10.

As noted above, first cartridge half 14 and second cartridge half 16 may be configured to permit minor relative movement between the first cartridge half 14 and the second cartridge half 16. In some cases, first O-ring 76 and second O-ring 78 interact with the walls of valve cavity 80 and provide a compressive force pushing the first cartridge half 14 and the second cartridge half 16 together. This forces first seal 28 and second seal 30 into contact with ball valve 22, thereby providing a fluid-tight seal while providing a valve that may be opened and/or closed using a relatively light force.

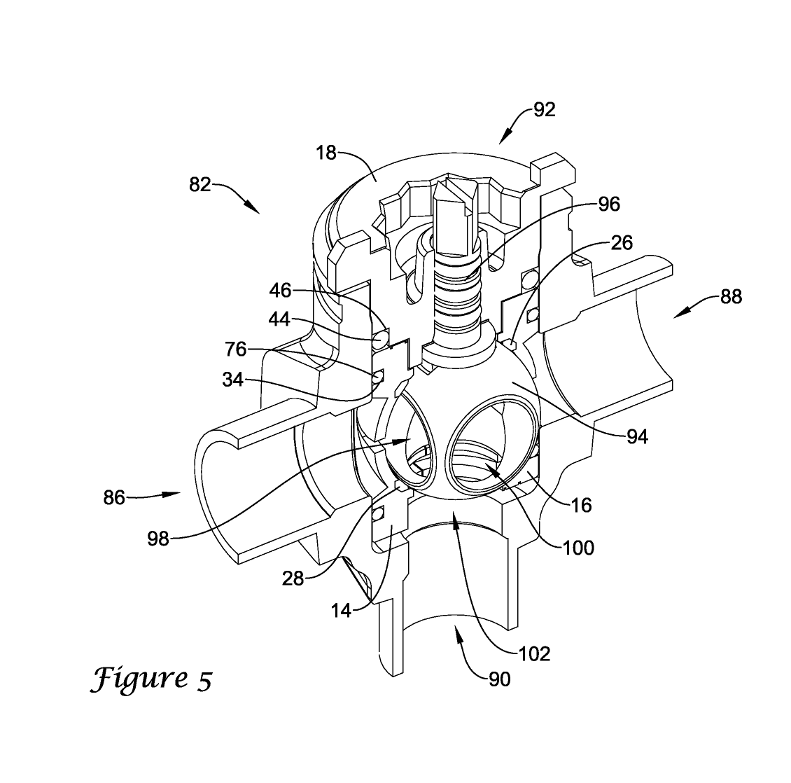

In some cases, a valve such as a ball valve may be a three-way valve useful in mixing and/or diverter applications. FIG. 5 is a partial cross-section of a valve 82 that is configured as a three-way valve and thus, depending on how it is plumbed, may be used as either a mixing valve or as a diverter valve. Much of the structure of valve 82 is similar to that described previously with respect to valve 64 and valve body 66, aside from elements expressly noted. Valve 82 includes a valve body 84 having a first port 86, a second port 88 and a third port 90. A valve cartridge 92 is disposed within valve body 84.

Valve cartridge 92 includes a ball valve 94 and stem 96. In some cases, stem 96 may be integrally formed with ball valve 94. In some instances, ball valve 94 and stem 96 may be separately formed and then subsequently attached to each other. In the illustrated embodiment, ball valve 94 includes a first aperture 98, a second aperture 100 that in some instances may be positioned about 90 degrees away from first aperture 98, and a third aperture 102 that may be positioned perpendicular to first aperture 98 and perpendicular to second aperture 100.

In some instances, third aperture 102 may remain aligned with third port 90. Ball valve 94 may be rotated such that first aperture 98 may be at least substantially aligned with first port 86, as illustrated. In this position, fluid flow between first port 86 and third port 90 may be permitted. It can be seen that by rotating ball valve 94 approximately a quarter-turn, second aperture 100 may be at least substantially aligned with second port 88. In such a position, fluid flow between second port 88 and third port 90 may be permitted.

If valve 82 is used as a mixing valve, valve 82 may be plumbed such that a fluid may enter either through first port 86, through second port 88 or through both first port 86 and second port 88, depending on the exact rotational position of ball valve 94. Fluid may then exit through third port 90. The fluid exiting third port 90 may include only the fluid entering through first port 86. The fluid exiting third port 90 may include only the fluid entering through second port 88. In some cases, the fluid exiting through third port 90 may include a combination of the fluid entering through first port 86 and the fluid entering through second port 88.

If valve 82 is to be used as a diverter valve, valve 82 may be plumbed such that a fluid may enter through third port 90. Fluid may exit through first port 86, second port 88 or may exit through first port 86 and through second port 88, depending on the relative rotational position of ball valve 94.

Valve 64 (or valve 82) may be employed in, for example, heating and cooling systems. In a heating system, a heat source such as a gas-fired or electric boiler may be used to heat water to a suitable temperature and a pump or other motive source may be used to pump the heated water through a distribution network of pipes to one or more radiators, hot water baseboard heaters, encapsulated tubing such as in a radiant floor system, and/or the like. The distribution network can include water lines or pipes that extend from the heat source to one or several radiators and the like. In some embodiments, the distribution network can be deployed in a larger building such as an apartment or condominium building and can involve a large number of radiators, baseboard heaters or radiant floor systems, and in some cases multiple zones.

Regardless of system size, one or more valves 64 (or valves 82) can be plumbed into the distribution network to control the flow of heated water through the system. A single valve 64 (or valve 82) can be used to regulate water flow through a single radiator or baseboard heater. In some embodiments, each valve 64 (or valve 82) can be used to regulate water flow through several radiators or the like.

If a need arises to replace part or all of valve assembly 10 once valve 64, for example, has been plumbed into a system, it will be recognized that valve assembly 10 may be removed from valve body 66 by removing retainer 72 and lifting valve assembly 10 out. A new valve assembly 10 may then be inserted into valve cavity 80, within valve body 66, and retainer 72 may be reinserted to secure valve assembly 10 in place. In some cases, once valve assembly 10 is removed, only part of valve assembly 10 is replaced. In some cases, valve assembly 10 may be repaired and/or replaced without removing valve body 66 from the system into which valve 64 is plumbed. Similar repairs may be made to valve 82.

The invention should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

1. A valve, comprising:
a valve body defining a valve cavity defined by one or more walls; and
a valve assembly disposed within the valve cavity, the valve assembly comprising:
a cartridge including a first cartridge half and an opposing second cartridge half that snap loosely together so that the first cartridge half and the second cartridge half are loosely secured together when the cartridge is outside of the valve cavity and so that the first cartridge half and the second cartridge half can move closer together in response to a compressive force developed between the cartridge and one or more walls of the valve cavity when the cartridge is inserted into the valve cavity;
a first seal and a second seal disposed within the cartridge; and
a ball valve disposed between the first seal and the second seal;
wherein the first seal and the second seal are held against the ball valve via the compressive force developed between the cartridge and one or more walls of the valve cavity.

2-4. (canceled)

5. The valve of claim 1, further comprising a first O-ring disposed proximate an exterior surface of the first cartridge half and a second O-ring disposed proximate an exterior surface of the second cartridge half.

6. The valve of claim 5, wherein the first O-ring and the second O-ring contact one or more walls of the valve cavity sufficiently to provide the compressive force to the cartridge.

7. The valve of claim 1, further comprising an upper cartridge portion.

8. The valve of claim 7, wherein the ball valve comprises a shaft extending upward through the upper cartridge portion.

9. The valve of claim 7, further comprising a third O-ring disposed proximate an exterior surface of the upper cartridge portion.

10. The valve of claim 1, wherein the first seal and the second seal comprise low friction polymeric seals.

11. The valve of claim 1, wherein the first seal and the second seal comprise polytetrafluoroethylene seals.

12. The valve of claim 1, wherein the valve assembly is configured to be held in place within the valve cavity via a retainer that interacts with the valve assembly and the valve body.

13. The valve of claim 1, wherein the cartridge comprises a profile window that is integrally molded with at least part of the cartridge.

14. A ball valve cartridge assembly, comprising:
a first cartridge half;
a second cartridge half, the first cartridge half and the second cartridge half being moveably secured to one another such that the first cartridge half can move relative to the second cartridge half
a ball valve assembly disposed between the first cartridge half and the second cartridge half;
a first polymeric seal in contact with the first cartridge half and in sliding contact with the ball valve assembly; and
a second polymeric seal in contact with the second cartridge half and in sliding contact with the ball valve assembly.

15. The ball valve cartridge assembly of claim 14, wherein the first polymeric seal is molded into the first cartridge half.

16. The ball valve cartridge assembly of claim 14, wherein the first polymeric seal comprises a separately formed low friction material.

17. The ball valve cartridge assembly of claim 14, wherein the second polymeric seal is molded into the second cartridge half.

18. The ball valve cartridge assembly of claim 14, wherein the second polymeric seal comprises a separately formed low friction material.

19. (canceled)

20. A ball valve cartridge assembly, comprising:
a cartridge comprising a first cartridge section and a second cartridge section;
a first seal disposed within the cartridge;
a second seal disposed within the cartridge;
a ball valve disposed between the first seal and the second seal; and
a profile window molded into the first cartridge section;
wherein the ball valve cartridge assembly is configured to be replaceable within a valve body without disassembling the valve body by removing a retainer that holds the ball valve cartridge assembly within the valve body.

21. The ball valve cartridge of claim 20, further comprising an upper cartridge.

22. The ball valve cartridge assembly of claim 20, wherein the first cartridge section comprises a molded polymer.

23. The ball valve cartridge assembly of claim 20, wherein the second cartridge section comprises a molded polymer.

24. The ball valve cartridge assembly of claim 21, wherein the upper cartridge comprises a molded polymer.

25. The ball valve cartridge assembly of claim 20, wherein the first seal comprises an at least partially spherically shaped annular seal.

26. The ball valve cartridge assembly of claim 20, wherein the second seal comprises an at least partially spherically shaped annular seal.

27. The valve of claim 12, wherein the valve assembly is configured to be removable from the valve cavity when the retainer is removed from the valve body.

28. The valve of claim 20, wherein the retainer has a snap fit with the ball valve cartridge assembly.

29. The valve of claim 28, wherein the retainer also has a snap fit with the valve body.

30. A ball valve cartridge assembly for use in a valve body, wherein the valve body includes a valve body inlet, a valve body outlet and a ball valve cartridge assembly receiving cavity in fluid communication with the valve inlet and the valve outlet, the valve inlet and the valve outlet having fixed positions relative to one another, the ball valve cartridge assembly comprising:
a cartridge comprising a first cartridge section and a second cartridge section;
a first seal disposed within the cartridge;
a second seal disposed within the cartridge; and
a ball valve disposed between the first seal and the second seal;
wherein the ball valve cartridge assembly is configured to be replaceable within the ball valve cartridge assembly receiving cavity of the valve body without having to move the valve inlet and the valve outlet relative to one another.

31. The ball valve cartridge assembly of claim 30, wherein the valve inlet and the valve outlet are plumbed into a water line.

32. The ball valve cartridge assembly of claim 30, further comprising a retainer having a snap fit with the ball valve cartridge assembly and a snap fit with the valve body, wherein the ball valve cartridge assembly is replaceable by removing the retainer from the ball valve cartridge assembly and the valve body.
